(19) United States
(12) Patent Application Publication
(10) Pub. No.: US 2005/0278711 A1
(43) Pub. Date: Dec. 15, 2005

(54) Method and assembly for processing, viewing and installing command information transmitted by a device for manipulating images

(76) Inventors: Sonia Da Silva, Igny (FR); Yves Trousset, Palaiseau (FR); Pascal Salazar-Ferrer, Chevreuse (FR)

Correspondence Address: CANTOR COLBURN, LLP, 55 GRIFFIN ROAD SOUTH, BLOOMFIELD, CT, 06002, US

(21) Appl. No.: 10/722,844

(22) Filed: Nov. 26, 2003

(30) Foreign Application Priority Data
Nov. 28, 2002 (FR) 02 14994

(51) Int. Cl. G06F 9/45

(52) U.S. Cl. 717/143

(57) ABSTRACT

A method and assembly for processing, viewing and installing command information transmitted via a peripheral device for manipulating 3D modelling image(s). The peripheral device is a gripping element manipulated by a user and has sensors which detect forces and/or displacements on the gripping element and, as a result of detected forces and/or displacements, generate command information, some corresponding to translation or zoom components, and others to rotation components for the movement to be conferred to a spatial representation of the 3D modelling. In a first operating mode a set of command information is processed to modify the displayed image(s) by imparting thereto only movements of rotation in space and in that in a second operating mode a set of command information is processed to modify the displayed image(s) by imparting thereto only movements of translation or a zoom effect. The method is applicable to a surgical theater and/or examination room.

### CROSS-REFERENCE TO RELATED APPLICATIONS

This application claims the benefit of a priority under 35 USC 119(a)-(d) to French Patent Application No. 02 14994 filed Nov. 28, 2002, the entire contents of which are hereby incorporated by reference.

### BACKGROUND OF THE INVENTION

The present invention and embodiments thereof relates to a method and assembly for processing command information transmitted to means for processing via a device for manipulating images and, in particularly, manipulating 3D modelling images. The present invention and embodiments thereof also relates to an installation for viewing medical images in a surgical theater or examination room implementing the method. The present invention and embodiments thereof can be useful in interventional radiology or in medical applications in general, particularly in a real-time environment.

Peripheral input devices for manipulating 3D modelling images are already known. This type of peripheral device comprises a gripping element intended to be grasped by the user (mouse head in the case of a 3D mouse or a joystick type control lever), and means for forming force and/or displacement sensors which generate command information corresponding to the displacements and/or force applied by the user on the gripping element, i.e., head. The command information is transmitted to means for processing which manages the 3D modelling representation which is displayed on a screen and which converts the command information into movements given in space to the representation.

There is a growing demand for medical practitioners, such as radiologists or surgeons, to be able to manipulate 3D modelling images directly during surgery or examination. Peripheral devices for manipulating 3D modelling images known to date do not allow this in an optimum manner. In particular, such devices do not allow the flexibility in manipulating considered desirable when images are being, for example, viewed during a surgical operation. In particular, in a surgical theater or examination room, the radiologist or surgeon remains standing in an uncomfortable position and is not accustom to manipulating an information peripheral device and is likely to cause a certain number of involuntary movements on the peripheral device. Likewise, when a sterile sheet covers the peripheral device, the friction from this sheet on the peripheral device can cause parasite or unwanted movements.

Furthermore, in the case of a peripheral device with more than three degrees of freedom, and especially with six degrees of freedom, it can prove particularly difficult for the surgeon or radiologist to carry out fully controlled movements of translation or movements of rotation, since such movements correspond in general to relatively close movements or forces on the peripheral device.

### BRIEF DESCRIPTION OF THE INVENTION

An embodiment of the disclosed and claimed invention is directed to a method for processing command information transmitted via a peripheral device for manipulating 3D modelling images, the peripheral device comprising means for manipulating by a user and means for forming sensors which detect forces and/or displacements on the means for gripping as a result of detected forces and/or displacements generate command information, some corresponding to translation or zoom components, and others to rotation components for the movement to be conferred to a spatial representation of the 3D modelling. In a first operating mode the set of command information is processed to modify the displayed image by imparting thereto only movements of rotation in space and in a second operating mode the command information is processed to modify the displayed image by imparting thereto only movements of translation or a zoom effect.

An embodiment of the disclosed and claimed invention is also directed to an assembly comprising a peripheral device comprising means for manipulating 3D modelling images, at least one screen on which images are displayed, means for processing which control the display on the screen, means for linking enabling the peripheral device to transmit command information to the means for processing, the peripheral device comprising a gripping element manipulated by a user and means for forming sensors which detect forces and/or displacements on the gripping element and generate, in terms of detected forces and/or displacements command information, some corresponding to translation or zoom components, and others to rotation components for movement to be conferred to the spatial representation of the 3D modelling, the means for processing comprise means suitable for using the abovementioned method.

An embodiment of the disclosed and claimed invention is also directed to an installation for viewing medical images comprising an assembly of the type mentioned hereinabove, the peripheral device being placed in a surgical theatre and/or examination room.

### BRIEF DESCRIPTION OF THE DRAWINGS

Other characteristics and advantages of the invention will emerge from the following description, which is purely illustrative and non-limiting and which must be read with reference to the attached figures in which:

FIG. 1 is a diagrammatic illustration of a peripheral device for manipulating images and mean for processing to which it is linked;

FIG. 2 illustrates different stages of implementation processing according to an embodiment of the invention; and

FIG. 3 diagrammatically illustrates a surgical theater and/or examination room that includes a 3D image manipulation peripheral.

### DETAILED DESCRIPTION OF THE INVENTION

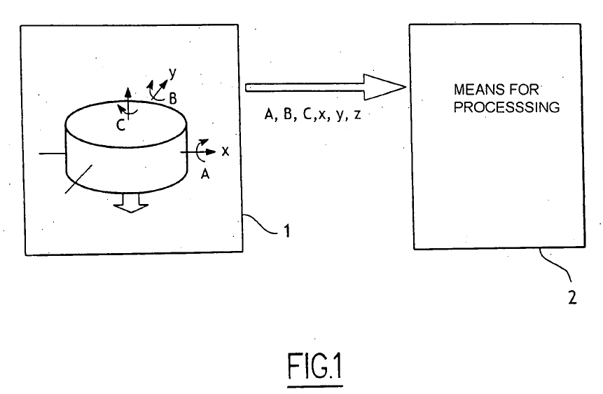

FIG. 1 illustrates means for manipulating, such as a peripheral device 1 for manipulating 3D modelling images and means for processing 2 to which the peripheral device is connected (by cable or by an RF link for example).

This peripheral device 1 can be a 3D mouse comprising a head, not illustrated here, which is articulated on a support at six degrees of freedom and means for forming sensors allowing the movements of the gripping head to be detected by six components corresponding to these six degrees of freedom and to transmit command information corresponding to these six components to the means for providing the command information.

The command information is transcribed by means for processing 2 to give a corresponding movement to the 3D modelling image whose screen display it controls. An example of a 3D mouse of this type is described in U.S. Pat. No. 4,785,180. The sensor of the 3D mouse is an optoelectronic sensor allowing six components to be detected: three translation components in three directions corresponding to three perpendicular axes and three rotation components corresponding to the rotations around these three axes. A further example of a peripheral device is described in co-pending patent application filed as of even date in the name of Salazar-Ferrer et al., entitled: “Device for Manipulating Images, Assembly Comprising Such a Device and Installation for Viewing Images”, (GE Docket 130600), which claims a priority under 35 USC 119(a)-(d) to French Patent Application No. 02 14992 filed on Nov. 28, 2002, the entire contents of which are hereby incorporated by reference.

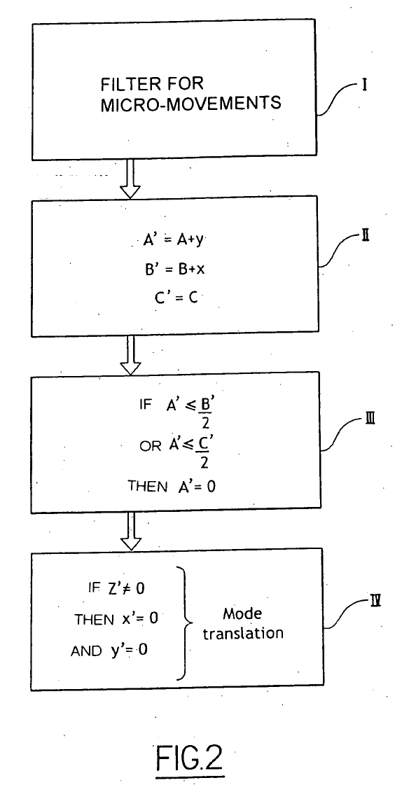

In the following description, command information is illustrated by three parameters of translation, “x”, “y” and “z”, and three parameters of rotation, “A”, “B” and “C”. The three parameters of translation “x”, “y” and “z” correspond to the amplitude of the components of movement along three perpendicular axes. The three parameters of rotation “A”, “B” and “C” correspond to the amplitude of components of movement of rotation about these same three axes. The six parameters are transmitted to the means for processing which utilize the steps illustrated in FIG. 2.

Referring to FIG. 2, in a first step (step I), the means for processing use filtering of the micro-movements on this command information. This filtering is, for example, a simple thresholding on the parameters of translation and rotation. Therefore, for example, a micro-movement on the mouse or more generally the peripheral device is avoided, due to the fact that the operator has moved the sterile sheet placed thereon or due to the fact that the operator has brushed the mouse without actually wanting to control it.

In a second step (step II), the information of translation and rotation is merged. For example, a linear combination of the parameter corresponding to translation “x” and of the parameter corresponding to rotation “B” is determined, as well as a linear combination of the parameter corresponding to translation “y” and the parameter corresponding to rotation “A”. By way of example, the parameters “x” and “B” are totalled and the same applies to the parameters “y” and “A”. The rotation “C” and translation “z” are not merged. The means for processing 2 impose on the user a choice between a “rotation” operating mode and a “translation” operating mode. The parameters resulting from the merging step are then utilized as command parameters for the rotation movement, if this occurs in the “rotation” operating mode, or for translation movement, if this occurs in the “translation” operating mode.

FIG. 2 illustrates the case where the following parameters are used as command parameters in the “rotation” operating mode:
A′=A+y
B′=B+x
C′=C

In the case of the “translation” operating mode for example the following new translation parameters are used:
x′=B+x
y′=A+x
z′=z

The movement of rotation or translation to be imposed by the user on the 3D image which is manipulated will be more rapid and efficacious: it will directly take into account for a single rotation movement or a single translation movement imposed on the 3D modelling image the sum of effects of translation and rotation imposed physically by the user on the peripheral device which is manipulated.

In a third step (step III), the parameters or values thus obtained are filtered to eliminate small translation/rotation components. For example, the parameter A′ is compared to B′/2 or as well as to C′/2. If A′ is less than B′/2 or C′/2 the parameter A′ is replaced by a zero value. In this way the rotation or translation components that are negligible or small relative to the other components are deleted. Similar comparison tests are used for the other parameters (B′, C′, x′, y′).

The filtering of the small components allows the user to more easily effect a clear rotation around an axis of choice. Furthermore, the filtering treatment does not prevent complex rotations (respectively translations) taking into account two or three rotation components (respectively along a give axis) at the same time. If none of the rotation components is small with respect to the other components, all of the components are taken into account of the final rotation component.

Steps I-III describes in the context of rotation and/or translation could be extended to other types of actions performed with a means for means manipulating. For example, the navigation along a reformatted cross-section (where the means for manipulating could be used to select both angles and a location of the current cross-section.

Filtering tests or comparative tests other than those just now described for step III are also possible.

In a fourth step, (step IV), when the peripheral device is used in “translation” operating mode, movement along the axis “z” is interpreted by the means for processing as a zoom command. To prevent this zoom movement from being perturbed by parasite or unwanted translation movements, filtering is used such that as soon as it is detected that the component “z′” is not equal or different from zero, the components “x′” and “y′” are replaced by zero values. In this way a non-perturbed and substantially clear zoom movement is effected.

The peripheral device is particularly adapted for use in an installation enabling viewing of medical images in a surgical theater and/or examination room. With such an installation, the peripheral device 1 can be placed in a surgical theater and/or examination room.

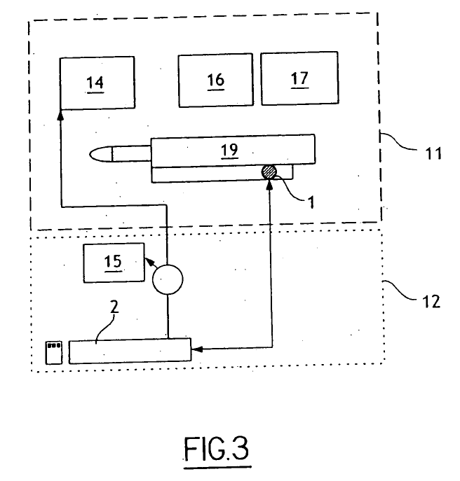

This is illustrated in FIG. 3, which shows a surgical theater and/or examination room 11, and an auxiliary control room 12 in which the calculation unit that forms the means for image processing 2 is located.

Means for processing 2 manages the 3D image display corresponding to data that it receives from a medical image acquisition device (not shown) arranged in room 11 (for example, a C arm type fluoroscopic acquisition device). More precisely, the means 2 receives control information from the peripheral device 1 manipulated by the surgeon or radiologist and that is located in the surgical theater and/or examination room 11, on the side of a table 19 on which the patient will be lying. Means 2 controls the display of 3D images on display monitors 14 and 15, with one (monitor 14) being placed in the room 11 and the other (monitor 15) being placed in the auxiliary control room (12). Cables connect the means 2 to peripheral device 1 and to monitors 14 and 15. Obviously, other means could be provided (for example RF transmission).

The surgical theater and/or examination room 11 may also comprise more than one monitor, for example, at least two other monitors 16 and 17 with complementary images which can be connected to the image of monitor 15 using means 2 as a function of control instructions sent by the surgeon or radiologist through peripheral device 1. Monitor 14 in room 11 can be a flat screen monitor that minimizes its size. It can be placed on a wall in room 11 or in an area of the room in which there is no or reduced risk of collision with the patient. For example, monitor 14 may be placed facing the operating table, on the side opposite peripheral device 1. For example, it may be adjacent to monitors 16, 17, for example, to the left side, and, if it this location is undesirable, if there is any risk of collision for the patient, to the right of the monitors.

In the installation for viewing or displaying an image comprising the above assembly at least one means for display can be placed in an room or facility (12) other than a surgical theater and/or examination room (11). In the installation for viewing or displaying an image comprising the above assembly the means for processing (2) can be placed in room (12) or facility other than a surgical theater and/or examination room (11).

An embodiment of the method and equivalents thereof has the following various characteristics taken singly or in combination:
processing for filtering the rotation and/or translation components corresponding to micro-movements is used on the command information;
at least one rotation component and at least one translation component are combined and in that the combined component(s) thus obtained is (are) utilized as rotation component(s) in the first operating mode and as translation component(s) in the second operating mode;
one combination used is a linear combination;
a comparison is used on the combined components intended to demonstrate the small components and in that in terms of the result of this comparison the component(s) thus demonstrated are replaced by a zero component: a combined component is replaced by a zero component when said component is less than a given ratio of at least one other component; a combined component is replaced by a zero component when the component is less than half of at least one other component;
in the second operating mode, after filtering of the micro-movements, whether the zoom component is zero or not is detected and in that when the latter is not zero, the other components are replaced by zero components.

Various modifications in way and/or function and/or result may be proposed or made by one skilled in the art to the disclosed embodiments and equivalents thereof without departing from the scope and extent of the invention.

1. A method for processing command information transmitted via means for manipulating images by a user and means for forming sensors which detect forces and/or displacements which, as a result of the detected forces and/or displacements, generate command information, some of which forces and/or displacements may correspond to translation or zoom components, and others of which forces and/or displacements may correspond to rotation components, for movement to be conferred to a spatial representation of the image, comprising:
processing in a first operating mode the command information to modify the image by imparting thereto only movements of rotation in space; and
processing in a second operating mode the command information to modify the image by imparting thereto only movements of translation or a zoom effect.

2. The method as claimed in claim 1 comprising filtering the command information for the rotation and/or translation components corresponding to micro-movements.

3. The method as claimed in claim 1 wherein at least one rotation component and at least one translation component are combined and the combined component(s) thus obtained is (are) utilized as rotation component(s) in the first operating mode and as translation component(s) in the second operating mode.

4. The method as claimed in claim 2 wherein at least one rotation component and at least one translation component are combined and the combined component(s) thus obtained is (are) utilized as rotation component(s) in the first operating mode and as translation component(s) in the second operating mode.

5. The method as claimed in claim 3 wherein one combination used is a linear combination.

6. The method as claimed in claim 4 wherein one combination used is a linear combination.

7. The method as claimed in claim 3 wherein a comparison is used on the combined components to identify components that are negligible or small relative to the other components and as a result of the comparison the component(s) thus identified are replaced by a zero component.

8. The method as claimed in claim 5 wherein a comparison is used on the combined components to identify components that are negligible or small relative to the other components and as a result of the comparison the component(s) thus identified are replaced by a zero component.

9. The method as claimed in claim 7 wherein a combined component is replaced by a zero component when the component is less than a given ratio of at least one other component.

10. The method as claimed in claim 8 wherein a combined component is replaced by a zero component when the component is less than a given ratio of at least one other component.

11. The method as claimed in claim 9 wherein a combined component is replaced by a zero component when the component is less than half of at least one other component.

12. The method as claimed in claim 8 wherein a combined component is replaced by a zero component when the component is less than half of at least one other component.

13. The method as claimed in claim 2 wherein in the second operating mode, after filtering of the micro-movements, whether the zoom component is zero or not is detected and when the zoom component is not zero, the other components are replaced by zero components.

14. The method as claimed in claim 3 wherein in the second operating mode, after filtering of the micro-movements, whether the zoom component is zero or not is detected and when the zoom component is not zero, the other components are replaced by zero components.

15. The method as claimed in claim 5 wherein in the second operating mode, after filtering of the micro-movements, whether the zoom component is zero or not is detected and when the zoom component is not zero, the other components are replaced by zero components.

16. The method as claimed in claim 7 wherein in the second operating mode, after filtering of the micro-movements, whether the zoom component is zero or not is detected and when the zoom component is not zero, the other components are replaced by zero components.

17. The method as claimed in claim 9 wherein in the second operating mode, after filtering of the micro-movements, whether the zoom component is zero or not is detected and when the zoom component is not zero, the other components are replaced by zero components.

18. The method as claimed in claim 11 wherein in the second operating mode, after filtering of the micro-movements, whether the zoom component is zero or not is detected and when the zoom component is not zero, the other components are replaced by zero components.

19. An assembly comprising:
means for manipulating an image;
at least one means for display of the image;
means for processing which control the display on the means for display;
means for linking enabling the means for manipulating to transmit command information to the means for processing;
the means for manipulating comprising:
a gripping element manipulated by a user;
means for forming sensors which detect forces and/or displacements on the gripping element and generate, in terms of detected forces and/or displacements, command information, some corresponding to translation or zoom components, and others to rotation components for movement to be conferred to a spatial representation of the image;
the means for processing comprise means suitable for using the method as claimed in any one of the preceding claims.

20. An installation for viewing or displaying an image comprising an assembly as claimed in claim 19 wherein the means for manipulating being placed in a surgical theater and/or examination room.

21. An installation for viewing or displaying an image comprising an assembly as claimed in claim 19 wherein at least one means for display being placed in a surgical theater and/or examination room.

22. An installation for viewing or displaying an image comprising an assembly as claimed in claim 20 wherein at least one means for display being placed in a surgical theater and/or examination room.

23. An installation for viewing or displaying an image comprising an assembly as claimed in claim 19 wherein at least one means for display being placed in an room or facility other than a surgical theater and/or examination room.

24. An installation for viewing or displaying an image comprising an assembly as claimed in claim 20 wherein at least one means for display being placed in an room or facility other than a surgical theater and/or examination room.

25. An installation for viewing or displaying an image comprising an assembly as claimed in claim 21 wherein at least one means for display being placed in an room or facility other than a surgical theater and/or examination room.

26. An installation for viewing or displaying an image comprising an assembly as claimed in claim 19 wherein the means for processing being placed in room or facility other than a surgical theater and/or examination room.

27. An installation for viewing or displaying an image comprising an assembly as claimed in claim 19 wherein the means for processing being placed in room or facility other than a surgical theater and/or examination room.

28. An installation for viewing or displaying an image comprising an assembly as claimed in claim 19 wherein the means for processing being placed in room or facility other than a surgical theater and/or examination room.

29. An installation for viewing or displaying an image comprising an assembly as claimed in claim 19 wherein the means for processing being placed in room or facility other than a surgical theater and/or examination room.
